(19) United States
(12) Patent Application Publication
(10) Pub. No.: US 2014/0241948 A1
(43) Pub. Date: Aug. 28, 2014

(54) REDUCTANT DELIVERY SYSTEM

(71) Applicant: Caterpillar Inc., Peoria, IL (US)

(72) Inventor: Brian M. Cole, Peoria, IL (US)

(73) Assignee: Caterpillar Inc., Peoria, IL (US)

(21) Appl. No.: 14/271,707

(22) Filed: May 7, 2014

(51) Int. Cl. B01D 53/92

(52) U.S. Cl. CPC B01D 53/92
USPC 422/111

(57) ABSTRACT

An aftertreatment system for the transport of fluid reductant to an exhaust of a combustion engine is provided. The aftertreatment system includes a reductant tank configured to store the reductant. The reductant tank has an in-tank filter. A pump module is fluidly coupled to the reductant tank. The pump module includes a pump housing, a pump motor, a pump filter and a pump. The pump is connected downstream of the pump filter. A pressure sensor is connected downstream of the pump. A return conduit is configured to return a portion of the reductant from downstream of the pump to upstream of the pump. A pressure regulator is present within the return conduit. The pump housing is structured and arranged to enclose the pump filter, the pressure sensor, the return conduit, the pump motor and the pressure regulator. A reductant injector is fluidly coupled to the pump module.

### TECHNICAL FIELD

The present disclosure relates to a fluid delivery system, and more specifically to a reductant delivery system.

### BACKGROUND

In low emission regulated machines, an aftertreatment system is associated with an engine system. The aftertreatment system is configured to treat and reduce NOx and/or other compounds of the emissions present in an exhaust gas flow, prior to the exhaust gas flow exiting into the atmosphere. In order to reduce NOx, the aftertreatment system may include a Selective Catalytic Reduction (SCR) module and a reductant delivery module.

The reductant delivery module may include a tank for storing a reductant, a pump, reductant delivery lines and a reductant injector. The reductant delivery lines may fluidly connect various components of the reductant delivery module for the flow of the reductant therethrough.

U.S. Pat. No. 7,334,399 discloses an apparatus, system, and method for intermittently delivering fluid. An injector intermittently delivers a first quantity of fluid over a first time interval. In a certain embodiment, the injector delivers the first quantity of fluid responsive to a fluid flow measurement of a flow meter. An orifice diverts the first quantity of fluid from a primary fluid supply system over a second time interval without decreasing the supply of fluid to a primary load within a flow rate range while the fluid pressure remains within a pressure range. An accumulator accumulates at the least the first quantity of fluid as a fluid charge with positive energy.

In known systems, the pump and other components, such as, for example filter elements, sensors and other devices for the delivery of the reductant to the reductant injector are structured as individual units that may occupy space and are expensive. Sometimes, these systems may be subject to more frequent servicing. More particularly, the filter elements situated between the tank and the pump may require more frequent inspection and service.

Hence, there is a need to provide an improved system for the circulation of the reductant from the tank to the reductant injector.

### SUMMARY OF THE DISCLOSURE

In one aspect of the present disclosure, an aftertreatment system for the transport of fluid reductant to an exhaust of a combustion engine is provided. The aftertreatment system includes a reductant tank configured to store the reductant. The reductant tank has an in-tank filter. A pump module is fluidly coupled to the reductant tank. The pump module includes a pump housing, a pump motor, a pump filter and a pump. The pump is connected downstream of the pump filter. A pressure sensor is connected downstream of the pump. A return conduit is configured to return a portion of the reductant from downstream of the pump to upstream of the pump. A pressure regulator is present within the return conduit. The pump housing is structured and arranged to enclose the pump filter, the pressure sensor, the return conduit, the pump motor and the pressure regulator. A reductant injector is fluidly coupled to the pump module.

Other features and aspects of this disclosure will be apparent from the following description and the accompanying drawings.

### BRIEF DESCRIPTION OF THE DRAWINGS

FIG. 1 is a block diagram of an exemplary aftertreatment system, according to one embodiment of the present disclosure;

FIG. 2 is a schematic view of a reductant tank, a pump module and a reductant injector, wherein the pump module includes a return conduit, according to one embodiment of the present disclosure; and

FIG. 3 is a schematic view of another return conduit, according to various embodiments of the present disclosure.

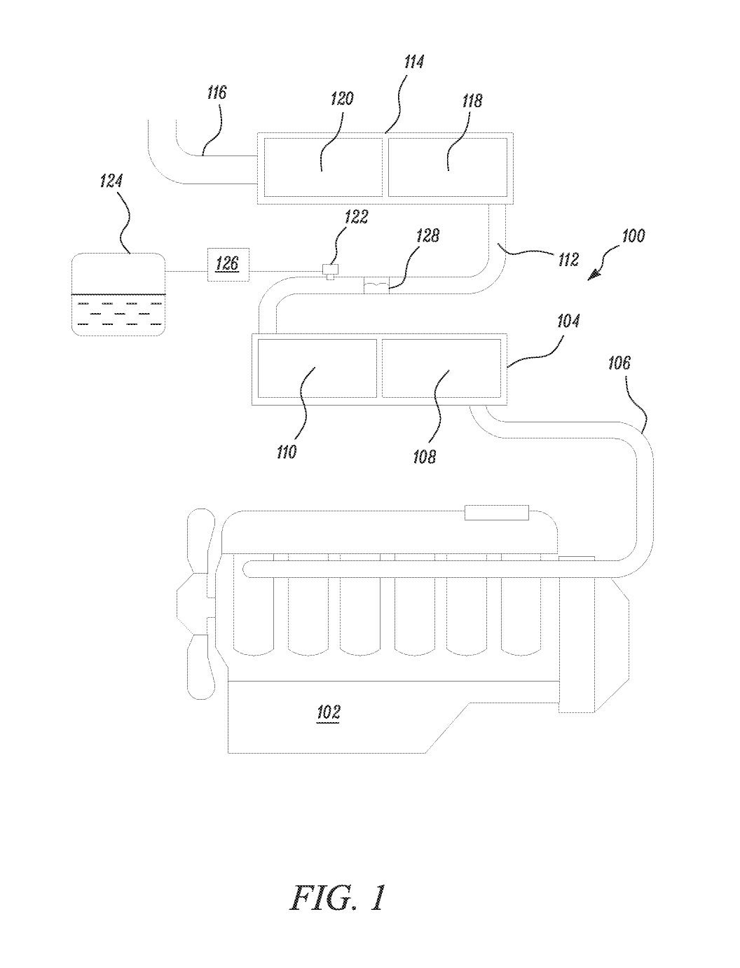

### DETAILED DESCRIPTION

Wherever possible, the same reference numbers will be used throughout the drawings to refer to the same or the like parts. FIG. 1 is a block diagram of an exemplary aftertreatment system 100 associated with an engine 102. The engine 102 may be associated with any machine. For example, the type of machine contemplated herein may be an earth-moving machine, such as a wheel loader, excavator, dump truck, backhoe, material handler, locomotive, paver or the like. Apart from mobile machines, the machine contemplated may be a stationary or portable machine such as a generator set, an engine driving a gas compressor or pump, and the like. Moreover, the machine may include or be associated with work implements such as those utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

The engine 102 may include any internal combustion engine known in the art including, but not limited to, a diesel-fueled engine, a gasoline-fueled engine, a natural gas-fueled engine or a combination thereof In the illustrated embodiment, the aftertreatment system 100 includes a first module 104 that is fluidly connected to an exhaust conduit 106 of the engine 102. During engine operation, the first module 104 is arranged to internally receive engine exhaust gas from the conduit 106. The first module 104 may contain various exhaust gas treatment devices such as a diesel oxidation catalyst (DOC) 108 and a diesel particulate filter (DPF) 110, but other devices may be used. The first module 104 and the components found therein are optional and may be omitted for various engine applications in which the exhaust treatment function provided by the first module 104 is not required.

In the illustrated embodiment, exhaust gas provided to the first module 104 by the engine 102 may first pass through the DOC 108 and then through the DPF 110 before entering a transfer conduit 112. The transfer conduit 112 fluidly interconnects the first module 104 with a second module 114 such that the exhaust gas from the engine 102 may pass through the first and second modules 104, 114 in series before being released at a stack 116 that is connected downstream to the second module 114. The second module 114 encloses an SCR catalyst 118 and an Ammonia Oxidation Catalyst (AMOX) 120. The SCR catalyst 118 operate to treat exhaust gas from the engine 102 in the presence of ammonia, which is provided after degradation of a urea-containing solution injected into the exhaust gas in the transfer conduit 112. The AMOX 120 is used to convert any ammonia slip from the downstream flow of the SCR catalyst 118 before exiting the exhaust gas through the stack 116.

More specifically, a reductant, for example, diesel exhaust fluid (DEF), is injected into the transfer conduit 112 by a reductant injector 122. The reductant is contained within a reductant tank 124 and is provided to the reductant injector 122 by a pump module 126. As the reductant is injected into the transfer conduit 112, the reductant mixes with the exhaust gas passing therethrough and is carried to the second module 114.

In order to promote mixing of the reductant with the exhaust gas, a mixer 128 may be disposed along the transfer conduit 112. The mixing of the reductant with the exhaust gas is not limited to a separate mixer 128 but may be accomplished with other known techniques such as a curved transfer conduit 112. The amount of the reductant that may be injected into the transfer conduit 112 may be appropriately metered based on engine operating conditions. The appropriate metering of the reductant may also be determined by other known techniques such as, a sensor (not shown) located upstream of the reductant injector 122 in a feed-forward control system, or a sensor located downstream of the reductant injector 122 in a feedback control system. Accordingly, a desired amount of reductant at desired times may be provided to the transfer conduit 112 via the reductant injector 122. It should be noted that the aftertreatment system 100, that is the components and their connections disclosed herein is exemplary and does not limit the scope of the present disclosure. The aftertreatment system 100 may additionally include other components not described herein. The design of the aftertreatment system 100 may vary based on the application.

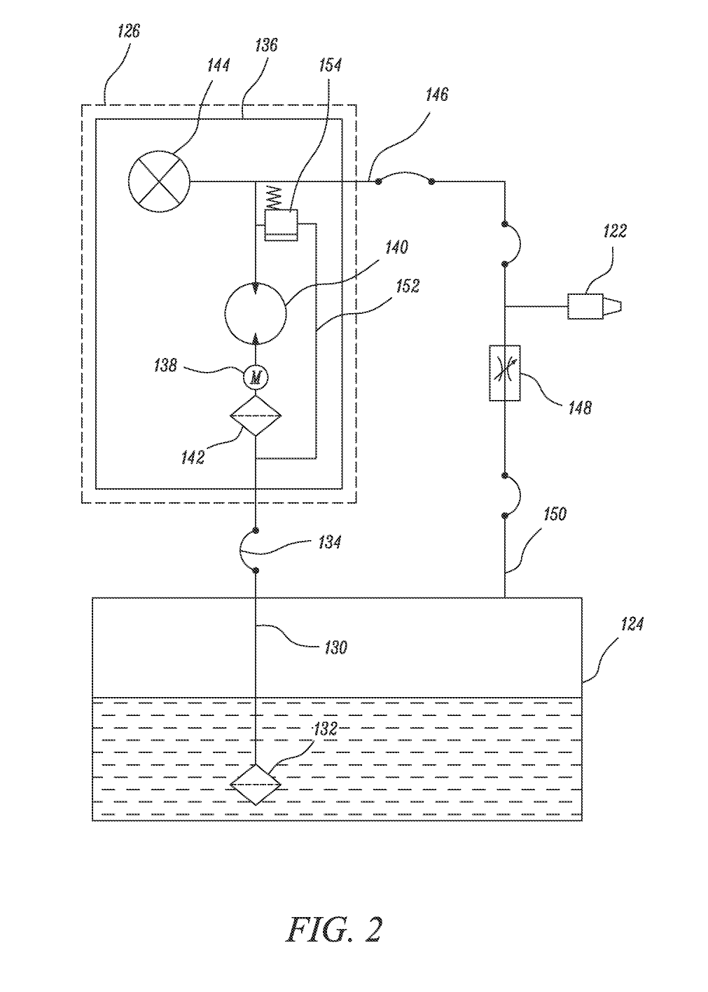

FIG. 2 is a schematic view of the reductant tank 124, the pump module 126 and the reductant injector 122. The reductant tank 124 is configured to store the reductant therein. A fluid draw conduit 130 is disposed within the reductant tank 124 and arranged and configured to draw the reductant from therewithin. An in-tank filter 132 is provided within the reductant tank 124. The in-tank filter 132 may include, for example, a staged filter arrangement having an outer filter, such as, a sock filter, and a secondary filter disposed along the fluid draw conduit 130. The reductant drawn from the fluid draw conduit 130 may be provided via a suction line 134 to the pump module 126.

The pump module 126 includes a pump housing 136 that is adapted to completely enclose a pump motor 138 driveably connected to a pump 140. The pump 140 may be a variable or fixed displacement pump operating at a variable or fixed speed depending on system configuration. The pump module 126 also includes a pump filter 142 to further filter the reductant before the same enters the pump 140, a pressure sensor 144 to measure reductant pressure at an outlet of the pump 140, a return line 152 and a pressure regulator 154.

The pressurized reductant at the outlet of the pump 140 is provided to a pressure line 146. The reductant may be provided to the reductant injector 122 for the dosing of the reductant into the exhaust gas flowing through the transfer conduit 112 (see FIG. 1). During operation, a continuous flow of the reductant may pass through the pressure line 146 and through a return orifice 148, which is disposed downstream of the reductant injector 122, before being provided back to the reductant tank 124 via a return line 150.

The return orifice 148 is configured to provide a restriction to ensure a continuous flow of the reductant is supplied to the reductant injector 122. A portion of the reductant from the pressure line 146 is used to cool the reductant injector 122. Accordingly, the continuous supply of the pressurized reductant may be provided to the reductant injector 122 during operation. For example, when a predetermined amount of the reductant is desired for injection from the reductant injector 122, a controller (not shown) may send a command signal to open the reductant injector 122 for a predetermined period to allow a predetermined amount of the reductant to be injected thereby.

During operation, the pump 140 is driven by the pump motor 138 at a predetermined speed and/or displacement, in general, at a predetermined flow rate, which may exceed the return flow of the reductant into the reductant tank 124 through the return orifice 148. Accordingly, the pump 140 may be driven to provide a quantity of the reductant to the pressure line 146 that exceeds the maximum reductant flow demand of the system by a predetermined amount, for example, 10 or 15% above the maximum expected flow through the reductant injector 122 when the reductant pressure in the system is at its maximum allowable value and the reductant injector 122 is fully open, i.e., when the reductant injector duty cycle is at 100%. As a result, the excess quantity of the filtered reductant may mix with the exhaust gas.

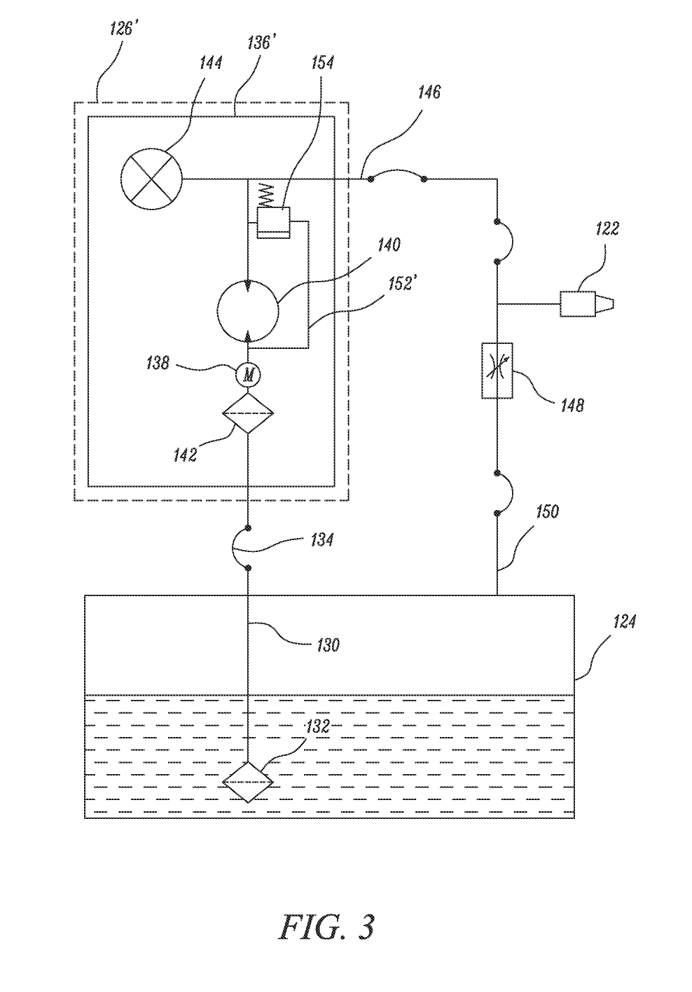

The present disclosure provides the return conduit 152 within the pump module 126, such that the return conduit 152 is configured to provide a portion of the reductant from the outlet of the pump 140 to the upstream of an inlet of the pump 140. In one embodiment, as shown in FIG. 2, the return conduit 152 may be connected upstream of the pump filter 142. Alternatively, as shown in FIG. 3, the return conduit 152′ may be connected to the inlet of the pump 140.

As shown in FIGS. 2 and 3, pump modules 126, 126′ respectively include the pressure regulator 154 connected downstream of the outlet of the pump 140. The pressure regulator 154 is configured to, at least in part, mitigate high pressure spikes in the pressure line 146. The pressure regulator 154 may include a valve element that is biased in a closed position via a spring and that, when open, the reductant may flow into the return conduit 152 (see FIG. 2) and return conduit 152′ (see FIG. 3) respectively. Alternatively, the pressure regulator 154 may include an electronic pressure regulator valve or a mechanical arrangement having a different configuration than that shown in the accompanying figures. The spring constant of the spring may be selected to yield an opening pressure for the valve element that is about the same or just above the normal operating pressure in the pressure line 146. Thus, pressure spikes may cause the automatic opening of the pressure regulator 154 and the portion of the reductant to flow into the return conduit 152 (see FIG. 2) and the return conduit 152′ (see FIG. 3) respectively. A person of ordinary skill in the art will appreciate that the pressure regulator 154 may be a sealed regulator when in the closed position so that the pump module 126 can prime.

Referring again to FIG, 2, during operation, at least a portion of the excessive reductant supply may recirculate in the pump module 126. In short, when the opening pressure of the pressure regulator 154 is selected to be about equal and, preferably, just below the desired fluid pressure under steady conditions within the pressure line 146, the excess reductant will be shunted back upstream of the pump 140 during the operation. The re-circulated reductant passes through the pump filter 142 and the pump 140. In contrast, in the embodiment illustrated in FIG. 3, the pump module 126′ directs the reductant into the inlet of the pump 140, upstream of the pump filter 142 via the return conduit 152′.

In conditions when the reductant injector 122 is open, the excess reductant flow provided by the pump 140 may cause the reductant to flow through the reductant injector 122 and through the return orifice 148 and back into the reductant tank 124. Further, the pressure regulator 154 may also be open, at least partially, to shunt the reductant back to the pump filter 142 or inlet of the pump 140.

### INDUSTRIAL APPLICABILITY

Referring to FIGS. 2 and 3, the present disclosure provides the return conduits 152, 152′ respectively within the respective pump modules 126, 126′ to allow the reductant to enter back into the inlet of the pump 140. This design of the pump modules 126, 126′ may extend the life of the in-tank filter 132. However, regarding the pump module 126′ shown in FIG. 3, the return conduit 152′ is structured and arranged within the pump housing 136′ of the pump module 126′ to allow the reductant to enter back into the inlet of the pump 140 downstream of the filter 142 which may act to further extend the life of the pump filter 142 and in-tank filter 132. Further, the design may also help with altitude capability and filter restriction based on a placement of the return flow.

Moreover, since the pump modules 126, 126′ respectively shown in FIGS. 2 and 3 enclose the sensor 144, the pressure regulator 154, the pump motor 138, the pump filter 142 and reductant lines therein the pump modules 126, 126′ are more compact and better protect the components therein. The pump modules 126, 126′ may be quickly serviced by replacing each pump module rather needing to service each individual component.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An aftertreatment system for the transport of fluid reductant to an exhaust of a combustion engine, the aftertreatment system comprising:
a reductant tank configured to store the reductant, the reductant tank having an in-tank filter;
a pump module fluidly coupled to the reductant tank, the pump module including:
a pump housing;
a pump motor;
a pump filter;
a pump connected downstream of the pump filter;
a pressure sensor connected downstream of the pump;
a return conduit configured to return a portion of the reductant from downstream of the pump to upstream of the pump; and
a pressure regulator present within the return conduit, wherein the pump housing is structured and arranged to enclose the pump filter, the pressure sensor, the return conduit, the pump motor and the pressure regulator; and
a reductant injector fluidly coupled to the pump module.
